(19) United States
(12) Patent Application Publication
(10) Pub. No.: US 2025/0309934 A1
(43) Pub. Date: Oct. 2, 2025

(54) IN-PHASE/QUADRATURE-PHASE (IQ) INTERFACE SWITCHING METHOD AND APPARATUS THEREOF

(71) Applicant: MEDIATEK INC., Hsinchu City (TW)

(72) Inventors: Shyuan LIAO, Hsinchu City (TW); Ying-Heng SHIH, Hsinchu City (TW); Tien-Shin HO, Hsinchu City (TW); Wei-Yu LAI, Hsinchu City (TW)

(21) Appl. No.: 18/618,117

(22) Filed: Mar. 27, 2024

(51) Int. Cl. H04B 1/40; H04L 27/36

(52) U.S. Cl. CPC H04B 1/40; H04L 27/361

(57) ABSTRACT

An in-phase/quadrature-phase (IQ) interface switching method is provided. The interface switching method may include the following steps. A transceiver of an apparatus may determine at least one condition to generate a detection result. Then, the transceiver may dynamically determine to use at least one analog IQ (AIQ) interface and/or at least one digital IQ (DIQ) interface based on the detection result to transmit IQ data from a radio frequency (RF) signal processing device of the transceiver to a baseband (BB) signal processing device of the transceiver.

### BACKGROUND OF THE INVENTION

### Field of the Invention

The invention generally relates to wireless communication technology, and more particularly, to an interface switching technology in which the transceiver can dynamically switch the analog in-phase/quadrature-phase (AIQ) interface and the digital IQ (DIQ) interface between radio frequency (RF) and baseband (BB) to transmit IQ data.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. The latest cellular telecommunication standard is 5G New Radio (NR), which is a set of enhancements to the LTE mobile standard promulgated by the Third Generation Partnership Project (3GPP). It is designed to better support mobile broadband Internet access by improving spectral efficiency, reducing latency, and improving services. 6G is the emerging cellular technology also promulgated by 3GPP for the next generation. 4G, 5G, and 6G are all one of the radio access technologies (RATs) defined by 3GPP. 5G NR is further divided into two frequency ranges (FRs): FR1 and FR2, according to the radio frequency used. 6G is expected to, like 5G, be also divided into multiple FRs.

In conventional technology, a transceiver (or modem circuit) of a communication apparatus may comprise a baseband (BB) chip and a radio frequency (RF) chip. In addition, there are AIQ interface and/or DIQ interface configured between the BB chip and the RF chip. Each AIQ interface may have two or four wires to transmit the IQ data (analog signals) from an antenna. Each DIQ interface may have a lane to transmit the IQ data (digital signals) from one or more antennas. Comparing to AIQ interface, the DIQ interface may have higher transmission capability per wire, but the DIQ interface may need higher power consumption.

However, in conventional technology, the interface (e.g., AIQ interface and DIQ interface) between RF and BB used or configured for a given RAT (or a given FR of that RAT) is fixed. Therefore, when a DIQ interface is configured for a RAT (or an FR of a RAT) and there is less data to be transmitted over the RAT (or the FR of the RAT) currently, the power of the communication apparatus will be wasted.

Therefore, how to efficiently and flexibly switch the AIQ interface and the DIQ interface is a topic that is worthy of discussion.

### BRIEF SUMMARY OF THE INVENTION

An in-phase/quadrature-phase (IQ) interface switching method and an apparatus are provided to overcome the problems mentioned above.

An embodiment of the invention provides an in-phase/quadrature-phase (IQ) interface switching method. The interface switching method includes the following steps. A transceiver of an apparatus may determine at least one condition to generate a detection result. Then, the transceiver may dynamically determine to use at least one analog IQ (AIQ) interface and/or at least one digital IQ (DIQ) interface based on the detection result to transmit IQ data of a RAT (or an FR of a RAT) from a radio frequency (RF) signal processing device of the transceiver to a baseband (BB) signal processing device of the transceiver.

In some embodiments, the IQ data may be associated with a radio access technology (RAT) or a frequency range (FR) of a RAT.

In some embodiments, the RAT or the frequency range of a RAT may comprise a 4G, a 5G frequency range 1 (FR1), a 5G frequency range 2 (FR2), or one of 6G frequency ranges.

In some embodiments, the at least one condition may comprise the number of antennas for the IQ data, the number of component carriers (CCs) for the IQ data, and/or a bandwidth (BW).

In some embodiments, the transceiver determines to use only the AIQ interface to transmit the IQ data of a RAT (or an FR of a RAT) in response to the number of antennas and the number of CCs of the RAT (or the FR of a RAT) for the IQ data being not greater than a threshold; and the transceiver determines to use the DIQ interface or both of the AIQ interface and the DIQ interface to transmit the IQ data in response to the number of antennas and the number of CCs for the IQ data being greater than the threshold.

In some embodiments, each AIQ interface comprises two or four wires and each AIQ interface is used for one antenna and one CC.

In some embodiments, each DIQ interface comprises a lane, an IQ data combining circuit and an IQ data dispatch circuit, and each DIQ interface is used for one or more antennas and one or more CCs.

An embodiment of the invention provides an apparatus for in-phase/quadrature-phase (IQ) interface switching. The apparatus may comprise a transceiver and a decision unit. The transceiver may comprises a baseband (BB) signal processing device, a radio frequency (RF) signal processing device, at least one analog IQ (AIQ) interface, at least one digital IQ (DIQ) interface, and switch circuits inside the RF signal processing device and BB signal processing device. The decision unit may be coupled to or inside the transceiver. The decision unit may determine at least one condition to generate a detection result, and dynamically determine, via the switch circuits of the transceiver, to use the at least one AIQ interface and/or the at least one DIQ interface based on the detection result to transmit IQ data of a RAT (or an FR of a RAT) from the RF signal processing device of the transceiver to the BB signal processing device of the transceiver.

An embodiment of the invention provides a transceiver for in-phase/quadrature-phase (IQ) interface switching. The transceiver may comprise a baseband (BB) signal processing device, a radio frequency (RF) signal processing device, at least one analog IQ (AIQ) interface, at least one digital IQ (DIQ) interface, a first switch circuit, a second switch circuit, and a decision unit. The at least one AIQ interface may be coupled to the BB signal processing device and the RF signal processing device. The at least one DIQ interface may be coupled to the BB signal processing device and the RF signal processing device. The first switch circuit may be coupled to one end of each AIQ interface involved in the IQ switching and one end of each DIQ interface involved in the IQ switching. The second switch circuit may be coupled to the other end of each AIQ interface involved in the IQ switching and the other end of each DIQ interface involved in the IQ switching. The decision unit may be coupled to the first switch circuit and the second switch circuit. The decision unit may generate a detection result to control the first switch circuit and the second switch circuit. The first switch circuit and the second switch circuit are so controlled to use the at least one AIQ interface and/or the at least one DIQ interface based on the detection result associated with at least one condition to transmit IQ data of a RAT (or an FR of a RAT) from the RF signal processing device to the BB signal processing device.

Other aspects and features of the invention will become apparent to those with ordinary skill in the art upon review of the following descriptions of specific embodiments of the IQ interface switching method and an apparatus.

### BRIEF DESCRIPTION OF THE DRAWINGS

The invention will become more fully understood by referring to the following detailed description with reference to the accompanying drawings, wherein:

FIG. 1 is a block diagram of a wireless communications system 100 according to an embodiment of the invention.

FIG. 2 is a block diagram of a communication apparatus 200 according to an embodiment of the invention.

FIG. 3 is a block diagram of a network apparatus 300 according to an embodiment of the invention.

FIG. 4 is a schematic diagram illustrating a transceiver 400 according to an embodiment of the invention.

FIG. 5A is a schematic diagram illustrating a result of an IQ interface switching according to an embodiment of the invention.

FIG. 5B is a schematic diagram illustrating a result of an IQ interface switching according to another embodiment of the invention.

FIG. 6 is a flow chart illustrating an IQ interface switching method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

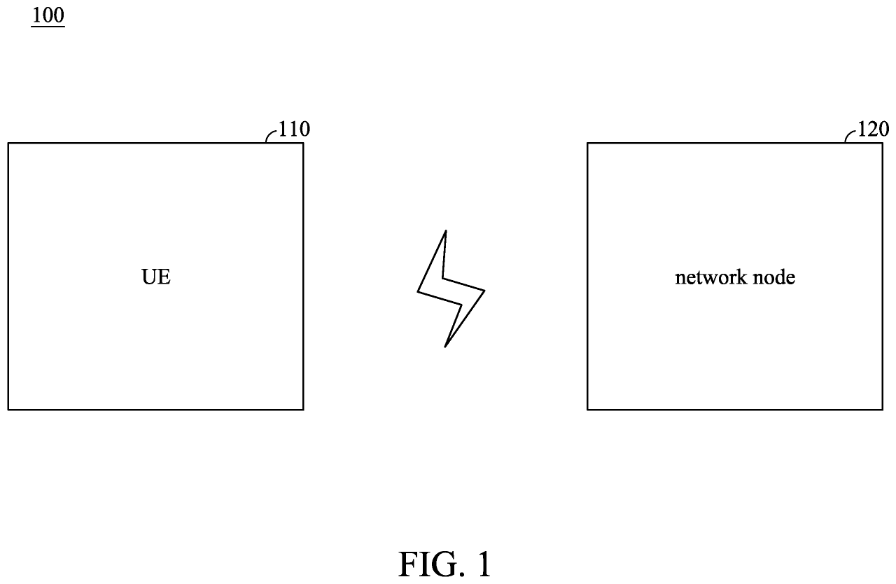

FIG. 1 is a block diagram of a wireless communications system 100 according to an embodiment of the invention. As shown in FIG. 1, the wireless communications system 100 may comprise user equipment (UE) 110 and a network node 120. It should be noted that in order to clarify the concept of the invention, FIG. 1 presents a simplified block diagram in which only the elements relevant to the invention are shown. However, the invention should not be limited to what is shown in FIG. 1.

In the embodiments of the invention, the UE 110 may be a smartphone, Personal Data Assistant (PDA), pager, laptop computer, desktop computer, wireless handset, smartwatch, wearable device, wireless router, internet of things (IoT) device, or any device that includes a wireless communications interface with cellular technologies.

In the embodiments, the network node 120 may be a base station, a gNodeB (gNB), a NodeB (NB), an eNodeB (eNB), an access point, or an access terminal, but the invention should not be limited thereto. In the embodiments, the UE 110 may communicate with the network node 120 through the fourth generation (4G) communication technology, fifth generation (5G) communication technology (or 5G New Radio (NR) communication technology), or sixth generation (6G) communication technology, but the invention should not be limited thereto.

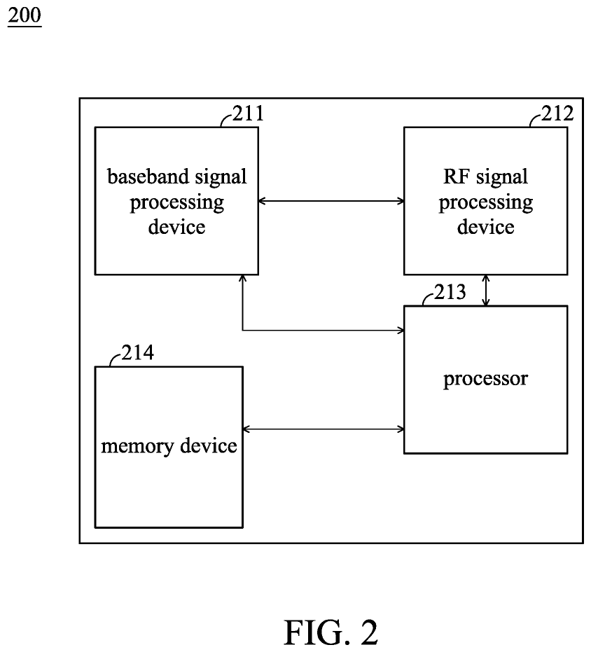

FIG. 2 is a block diagram of a communication apparatus 200 according to an embodiment of the invention. The communication apparatus 200 may be applied to UE 110. As shown in FIG. 2, the communication apparatus 200 may comprise at least a baseband signal processing device 211, a radio frequency (RF) signal processing device 212, a processor 213 and a memory device 214. It should be noted that in order to clarify the concept of the invention, FIG. 2 presents a simplified block diagram in which only the elements relevant to the invention are shown. However, the invention should not be limited to what is shown in FIG. 2.

The baseband signal processing device 211 and the RF signal processing device 212 may be integrated to form a transceiver. In the embodiments of the invention, there are at least one analog in-phase/quadrature-phase (AIQ) interface and at least one digital IQ (DIQ) interface between the baseband signal processing device 211 and the RF signal processing device 212 in the transceiver. According to an embodiment of the invention, the transceiver may form a modem (MD) of the communication apparatus 200, and the processor 220 may form an application processor (AP) of the communication apparatus 200.

The baseband signal processing device 211 may further process the baseband signals to obtain information or data transmitted by the peer communications apparatus. The baseband signal processing device 211 may also comprise a plurality of hardware elements to perform baseband signal processing. For example, the baseband signal processing device 211 may comprise DFE (digital front-end).

The RF signal processing device 212 may comprise a plurality of antennas to receive or transmit RF signals. The RF signal processing device 212 may receive RF signals via the antennas and process the received RF signals to convert the received RF signals to baseband signals to be processed by the baseband signal processing device 211, or receive baseband signals from the baseband signal processing device 211 and convert the received baseband signals to RF signals to be transmitted to a peer communications apparatus. The RF signal processing device 212 may comprise a plurality of hardware elements to perform radio frequency conversion. For example, the RF signal processing device 212 may comprise a low-noise amplifier (LNA), a mixer, analog-to-digital converter (ADC)/digital-to-analog converter (DAC), DFE (digital front-end), etc.

The baseband signal processing device 211 may control (some of) the operations of the RF signal processing device 212. According to an embodiment of the invention, the baseband signal processing device 211 may comprise a decision unit which may control the IQ interface switching function of the invention via a control interface between the baseband signal processing device 211 and the RF signal processing device 212. In the embodiment of the invention, the decision unit may determine at least one condition (or criterion) associated with the IQ data transmission to generate a detection result, which may be used to dynamically decide which IQ interface(s) to be used. In another embodiment, the decision unit may reside in the RF signal processing device 212. If the decision unit resides in the RF signal processing device 212, the decision unit may control the IQ interface switching function via the DIQ interface. That is, in this embodiment of the invention, the control interface may not exist.

The processor 213 may control the operations of the baseband signal processing device 211, the RF signal processing device 212, and the memory device 214. According to an embodiment of the invention, the processor 213 may also be arranged to execute the program codes of the software module(s) for controlling the corresponding baseband signal processing device 211 and the RF signal processing device 212. The program codes accompanied by specific data in a data structure may also be referred to as a processor logic unit or a stack instance when being executed. Therefore, the processor 213 may be regarded as being comprised of a plurality of processor logic units, each for executing one or more specific functions or tasks of the corresponding software modules.

The memory device 214 may store the software and firmware program codes, system data, user data, etc. of the communication apparatus 200. The memory device 214 may be a volatile memory such as a Random Access Memory (RAM), a non-volatile memory such as a flash memory or Read-Only Memory (ROM), a hard disk, or any combination thereof.

According to an embodiment of the invention, the RF signal processing device 212 and the baseband signal processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module and to provide wireless communications services in compliance with multiple RATs, and the invention should not be limited to what is shown in FIG. 2.

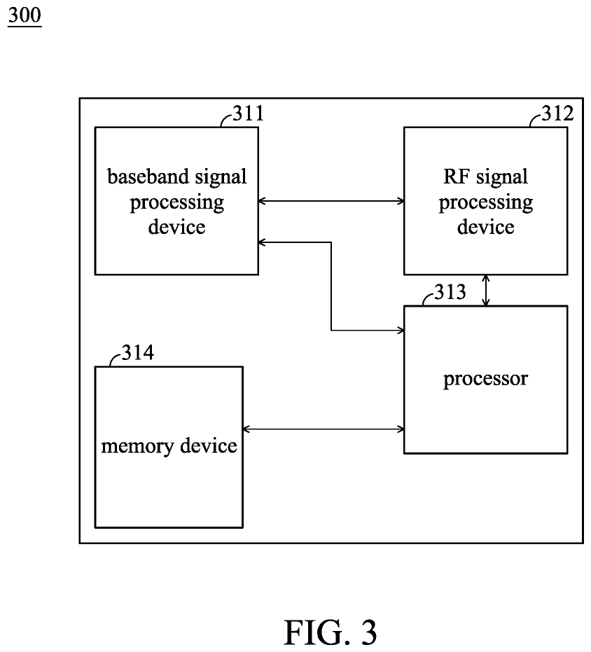

FIG. 3 is a block diagram of a network apparatus 300 according to an embodiment of the invention. The network apparatus 300 may be applied to the network node 120. As shown in FIG. 3, the network apparatus 300 may comprise at least a baseband signal processing device 311, a RF signal processing device 312, a processor 313, and a memory device 314. It should be noted that in order to clarify the concept of the invention, FIG. 3 presents a simplified block diagram in which only the elements relevant to the invention are shown. However, the invention should not be limited to what is shown in FIG. 3.

The baseband signal processing device 311 and the RF signal processing device 312 may be integrated to form a transceiver. In the embodiments of the invention, there are at least one AIQ interface and at least one DIQ interface are configured between the baseband signal processing device 311 and the RF signal processing device 312 in the transceiver.

The baseband signal processing device 311 may further process the baseband signals to obtain information or data transmitted by the peer communications apparatus. The baseband signal processing device 311 may also comprise a plurality of hardware elements to perform baseband signal processing.

The RF signal processing device 312 may comprise a plurality of antennas to receive or transmit RF signals. The RF signal processing device 312 may receive RF signals via the antennas and process the received RF signals to convert the received RF signals to baseband signals to be processed by the baseband signal processing device 311, or receive baseband signals from the baseband signal processing device 311 and convert the received baseband signals to RF signals to be transmitted to a peer communications apparatus. The RF signal processing device 312 may comprise a plurality of hardware elements to perform radio frequency conversion. For example, the RF signal processing device 312 may comprise a low-noise amplifier, a mixer, ADC/DAC, etc.

The processor 313 may control the operations of the baseband signal processing device 311, the RF signal processing device 312, and the memory device 314. According to an embodiment of the invention, the processor 313 may also be arranged to execute the program codes of the software module(s) for controlling the corresponding baseband signal processing device 311, and the RF signal processing device 312. The program codes accompanied by specific data in a data structure may also be referred to as a processor logic unit or a stack instance when being executed. Therefore, the processor 313 may be regarded as being comprised of a plurality of processor logic units, each for executing one or more specific functions or tasks of the corresponding software modules.

The memory device 314 may store the software and firmware program codes, system data, user data, etc. of the network node apparatus 300. The memory device 314 may be a volatile memory such as a RAM, a non-volatile memory such as a flash memory or ROM, a hard disk, or any combination thereof.

According to an embodiment of the invention, the RF signal processing device 312 and the baseband signal processing device 311 may collectively be regarded as a radio module capable of communicating with a wireless network to provide wireless communications services in compliance with a predetermined Radio Access Technology (RAT). Note that, in some embodiments of the invention, the network apparatus 300 may be extended further to comprise more than one antenna and/or more than one radio module and to provide wireless communications services in compliance with multiple RATs, and the invention should not be limited to what is shown in FIG. 3.

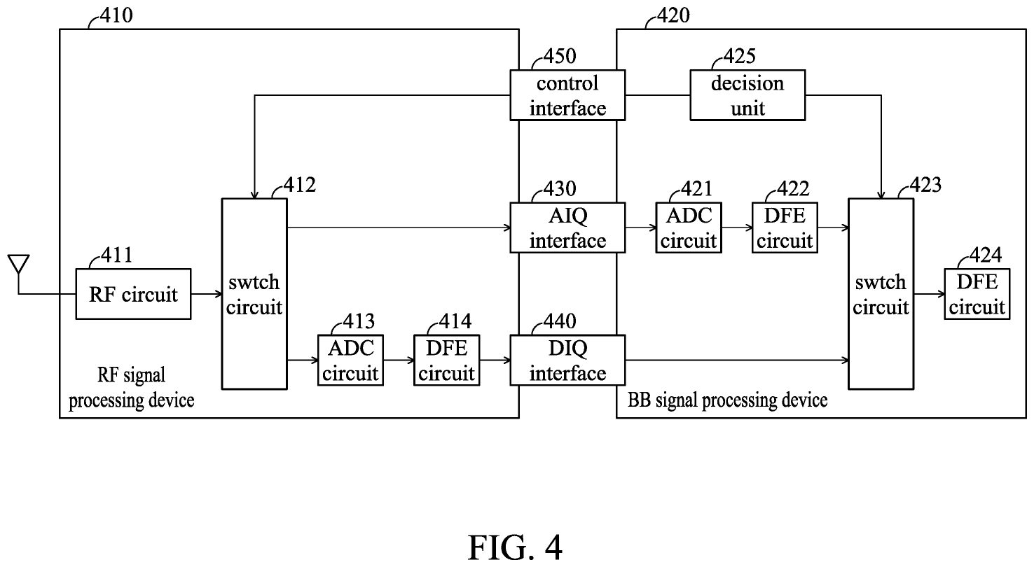

FIG. 4 is a schematic diagram illustrating a transceiver 400 according to an embodiment of the invention. The transceiver 400 may be applied to the UE 110 (or the communication apparatus 200) and the network node 120 (or the network apparatus 300). As shown in FIG. 4, the transceiver 400 may comprise a RF signal processing device (or RF chip) 410, a baseband (BB) signal processing device (or BB chip) 420, an AIQ interface (AIQ IF) 430, a DIQ interface (DIQ IF) 440, and a control interface (control IF) 450. It should be noted that FIG. 4 is only used to illustrate an embodiment of the invention, but the invention should not be limited thereto. For example, the transceiver 400 may comprise other elements. For another example, the transceiver 400 may comprise more than one AIQ interface 430 and more than one DIQ interface 440. For one more example, the control interface 450 may not exist due to the DIQ interface 440 used to transmit the control data.

The RF signal processing device 410 may comprise an RF circuit 411, a switch circuit 412, an ADC circuit 413 and a digital front-end (DFE) circuit 414, wherein the DFE circuit 414 is a front part of DFE, i.e., DFE-front. The BB signal processing device 420 may comprise an ADC circuit 421, a DFE circuit 422, a switch circuit 423, a DFE circuit 424, and a decision unit 425, wherein the DFE circuit 422 is a front part of DFE, DFE-front, and the DFE circuit 424 is a back part of DFE, i.e., DFE-back.

The RF circuit 411 may comprise one or more antennas, one or more low-noise amplifiers (LNAs), a plurality of mixers, but the invention should not be limited thereto. The switch circuit 412 and switch circuit 423 may be configured to determine the transmission path for the IQ data transmission between the RF signal processing device 410 and the baseband signal processing device 420 based on a detection result from the decision unit 425. That is, the switch circuit 412 and the switch circuit 423 may be configured so that the IQ data are transmitted through the AIQ interface 430, the DIQ interface 440, or both of the AIQ interface 430 and the DIQ interface 440 based on the detection result. The ADC circuit 413 and the ADC circuit 421 may convert analog signals to digital signals. The DFE circuit 414 may perform partial signal processing (i.e., the front part operations, DFE-front) for the signals from the ADC circuit 413. The DFE circuit 422 may perform partial signal processing (i.e., the front part operations of DFE-front) for the signals from the ADC 421. The DFE circuit 424 may perform remaining signal processing (i.e., the back part operations, DFE-back) for the signals from the DFE circuit 414 or the DFE circuit 422. Note that in another embodiment, the DFE circuit 414 and the DFE circuit 422 may comprise all the signal processing needed for the signals from the ADC circuit_413 and the ADC circuit 421, respectively, so there may be no DFE circuit 424 in the BB signal processing device 420.

The decision unit 425 may control the IQ interface switching function of the invention via the control interface 450. Specifically, the decision unit 425 may generate a detection result to control the switch circuit 412 and the switch circuit 423. In the embodiment of the invention, the decision unit 425 may determine at least one condition (or criterion) associated with the IQ data transmission to generate the detection result, which may be used to dynamically decide which IQ interface(s) to be used. In another embodiment, the decision unit 425 may be located in the RF signal processing device 410. If the decision unit 425 is located in the RF signal processing device 410, the decision unit 425 may control the IQ interface switching function via the DIQ interface. That is, in the embodiment of the invention, the control interface 450 may not exist. In addition, in another embodiment of the invention, the decision unit 425 may be realized by software.

The AIQ interface 430 may comprise two or four wires to transmit the in-phase data and the quadrature-phase data of the IQ data respectively. Each AIQ interface 430 may correspond to an antenna. The signals transmitted on the AIQ interface 430 are analog signals. The AIQ interface 430 may transmit the IQ data from the RF circuit 411 to the ADC circuit 421.

The DIQ interface 440 may comprise a lane and each lane may comprise two data wires to transmit the in-phase data and the quadrature-phase data of the IQ data respectively. The DIQ interface 440 may receive the IQ data from different antennas, i.e., the DIQ interface 440 may correspond to more than one antenna. Therefore, the DIQ interface 440 may further comprise an IQ data combining circuit and an IQ data dispatch circuit. The IQ data combining circuit may combine the IQ data from different antennas. The IQ data dispatch circuit may dispatch the IQ data from different antennas in the combined IQ data to the corresponding components in DFE circuits 424. The signals transmitted on the DIQ interface 440 are digital signals. The DIQ interface 440 may transmit the IQ data from the ADC circuit 413 to the switch circuit 423.

It should be noted that in some embodiment, some AIQ interfaces (or DIQ interfaces) may be fixed. That is, these fixed AIQ interfaces (or DIQ interfaces) may not be involved in the IQ interface switching of the invention.

According to an embodiment of the invention, when the UE 110 receives the IQ data of a RAT (or a frequency range (FR) of a RAT) from the network node 120, the UE 110 may determine at least one condition (or criterion) associated with the IQ data to generate a detection result. In an embodiment of the invention, the condition may comprise the number of antennas for the IQ data transmission of the RAT (or the FR of a RAT), the number of component carriers (CCs) for the IQ data transmission of the RAT (or the FR of a RAT), the bandwidth (BW) configured to the UE 110 for the IQ data of the RAT (or the FR of a RAT), or any combination thereof. Note that in an embodiment of the invention, the number of antennas for the IQ data transmission may be determined according to the received signal-to-noise ratio (SNR).

Then, the UE 110 may determine to use or enable the AIQ interface(s), the DIQ interface(s), or the AIQ interface(s) and the DIQ interface(s) based on the detection result to transmit the IQ data of the RAT (or the FR of a RAT) from the RF signal processing device of the UE 110 to the BB signal processing device of the UE 110. In addition, the UE 110 may dynamically determine whether to switch the enabled AIQ interface(s) and/or DIQ interface(s) based on the detection result associated with the current received IQ data transmission of the RAT (or the FR of a RAT).

According to an embodiment of the invention, when in an detection result, the UE 110 determines that the number of antennas for the current IQ data transmission of the RAT (or the FR of a RAT) is not greater than a first threshold and the number of CCs for the current IQ data transmission of the RAT (or the FR of a RAT) is not greater than a second threshold (the same as or different from the first threshold), or the joint function of the number of antennas and the number of CCs for the current IQ data transmission of the RAT (or the FR of a RAT) is not greater than a third threshold (the same as or different from the first and the second threshold) (i.e., there is less IQ data to be transmitted currently), the UE 110 may determine to only use the AIQ interface(s) to transmit the IQ data of the RAT (or the FR of a RAT) to save power. For example, if there are only one antenna and one CC to receive for the IQ data, the UE 110 may determine to use one AIQ interface to transmit the IQ data from the RF signal processing device of the UE 110 to the BB signal processing device of the UE 110 and to save power. In an example, the threshold may be pre-determined in accordance with the data transmission capability (e.g., bit per second (bps)) of one lane of the DIQ interface. Note that the determination criteria described above are made for the purpose of illustrating the embodiments of the invention, but the invention should not be limited thereto.

According to another embodiment of the invention, when in an detection result, the UE 110 determines that the number of antennas for the current IQ data transmission of the RAT (or the FR of a RAT) is greater than the first threshold, or the number of CCs for the current IQ data transmission of the RAT (or the FR of a RAT) is greater than the second threshold, or the joint function of the number of antennas and the number of CCs for the current IQ data transmission of the RAT (or the FR of a RAT) is greater than the third threshold (i.e., there may be larger IQ data needed to be transmitted), the UE 110 may determine to use the DIQ interface(s) or both of the AIQ interface(s) and the DIQ interface(s) to transmit the IQ data of the RAT (or the FR of a RAT) from the RF signal processing device of the UE 110 to the BB signal processing device of the UE 110.

According to another embodiment of the invention, when in an detection result, the UE 110 determines that the total BW configured to the UE 110 for the current IQ data transmission over all the CCs of the RAT (or the FR of a RAT) is greater than a threshold (i.e., there may be larger IQ data needed to be transmitted), the UE 110 may determine to use the DIQ interface(s) or both of the AIQ interface(s) and the DIQ interface(s) to transmit the IQ data of the RAT (or the FR of a RAT) from the RF signal processing device of the UE 110 to the BB signal processing device of the UE 110. For example, when the UE 110 is configured by the network node 120 with one 100 MHz-BW CC and one 20 MHz-BW CC for a RAT (or an FR of a RAT), the UE 110 may determine to use two DIQ interfaces to transmit the IQ data of the RAT (or the FR of a RAT) from the RF signal processing device of the UE 110 to the BB signal processing device of the UE 110, because a total BW of 120 MHz for the RAT (or the FR of a RAT) is larger than the 80 MHz threshold. In this example, the threshold may be pre-determined by the transmission capability of one line of the DIQ interface 440. Note that the determination criterion described above is made for the purpose of illustrating the embodiments of the invention, but the invention should not be limited thereto.

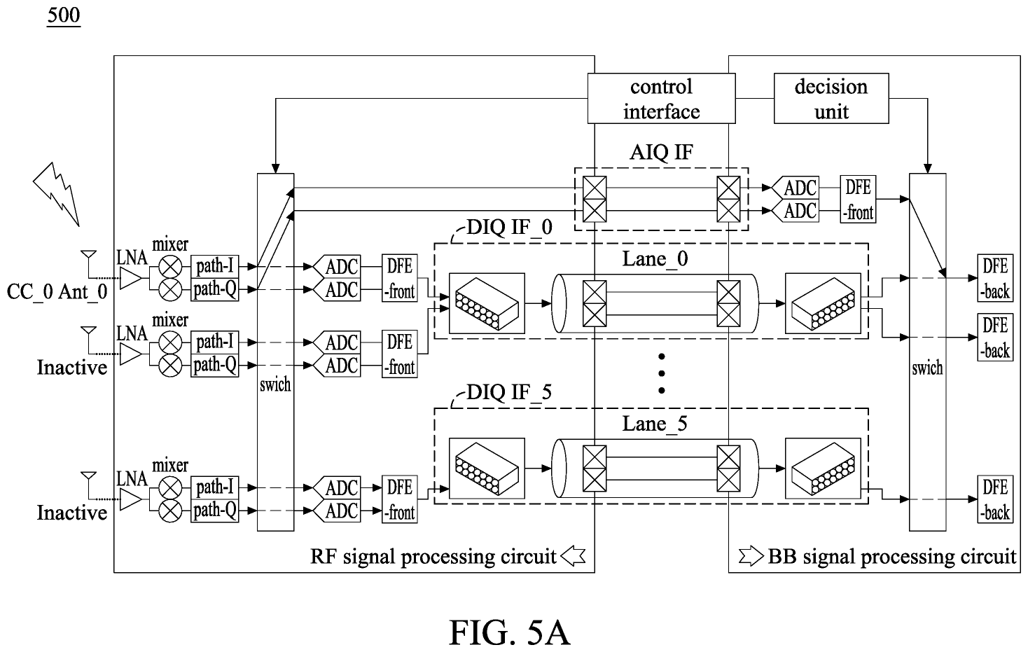

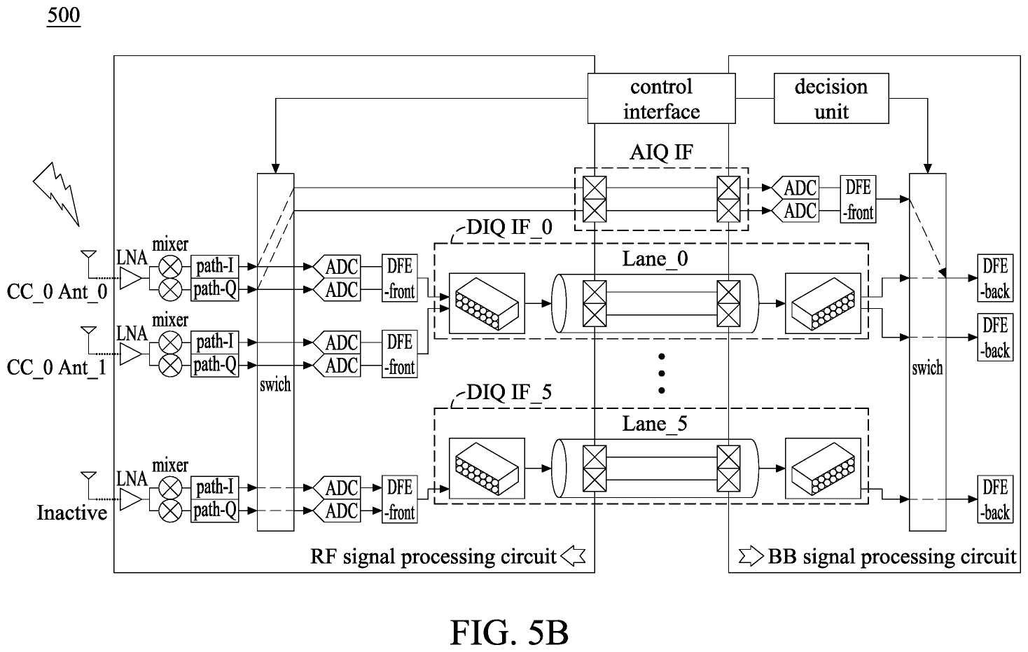

FIG. 5A is a schematic diagram illustrating a result (state) of IQ interface switching according to an embodiment of the invention. The IQ interface switching shown in FIG. 5A may be applied to the UE 110 and the network node 120. As shown in FIG. 5A, the transceiver 500 may comprise an RF signal processing device (or RF chip), a BB signal processing device (or BB chip), an AIQ interface (i.e., AIQ IF) and five DIQ interfaces (i.e., DIQ IF_0˜DIQ IF_5). The DIQ interfaces DIQ IF_0˜DIQ IF_5 may comprise Lane_0˜Lane_5 respectively. In FIG. 5A, it is assumed that the transceiver 500 is applied to the UE 110 and the UE 110 is configured by the network node 120 with one CC for a RAT (or an FR of a RAT), and the SNR of the RF signal of the RAT (or the FR of a RAT) is good enough such that only one antenna is needed to receive the RF signal. Accordingly, when the decision unit of the transceiver 500 generates a detection result associated with the received IQ data, it determines that the RF signal processing device of the transceiver 500 receives the IQ data only from the antenna Ant_0 corresponding to the component carrier CC_0, and that the switch circuits of transceiver 500 enable only the AIQ interface AIQ IF based on the detection result to transmit the IQ data from the RF signal processing device to the BB signal processing device through the AIQ interface AIQ IF to save power. That is, all DIQ interfaces are inactivated or disabled.

FIG. 5B is a schematic diagram illustrating another result (state) of IQ interface switching according to an embodiment of the invention. The IQ interface switching shown in FIG. 5B may be applied to the UE 110 and the network node 120. As shown in FIG. 5B, the transceiver 500 may comprise an RF signal processing device (or RF transceiver chip), a BB signal processing device (or BB chip), an AIQ interface (i.e., AIQ IF) and five DIQ interfaces (i.e., DIQ IF_0˜DIQ IF_5). The DIQ interfaces DIQ IF_0˜DIQ IF_5 may comprise Lane_0˜Lane_5 respectively. In FIG. 5B, it is assumed that the transceiver 500 is applied to the UE 110 and the UE 110 is configured by the network node 120 with one CC for a RAT (or an FR of a RAT), and the SNR of the RF signal of the RAT (or the FR of a RAT) is not good enough so that two antennas are needed to receive the RF signal. Accordingly, when decision unit of the transceiver 500 generates a detection result associated with the received IQ data, it determines that the RF signal processing device of the transceiver 500 receives the IQ data from the antenna Ant_0 and the antenna Ant_1 corresponding to the component carrier CC_0, and that the switch circuits of transceiver 500 enable only the DIQ interface DIQ IF_0 based on the detection result to transmit the IQ data from the RF signal processing device to the BB signal processing device through the DIQ interface DIQ IF_0. That is, the AIQ interface AIQ IF and other DIQ interfaces are inactivated or disabled. In addition, in FIG. 5B, the IQ data combining circuit of the DIQ interface DIQ IF_0 may combine the IQ data from antennas Ant_0 and Ant_1, and the IQ data dispatch circuit of the DIQ interface DIQ IF_0 may respectively dispatch the IQ data from antennas Ant_0 and Ant_1 in the combined IQ data to the corresponding components in DFE circuits.

It should be noted that the IQ interface switching of FIG. 5A and FIG. 5B are only used to illustrate the embodiments of the invention, but the invention should not be limited thereto.

According to an embodiment of the invention, the IQ data may be associated with a radio access technology (RAT) or an FR of a RAT. The RAT or the FR of a RAT may be a 4G, a 5G frequency range 1 (FR1), a 5G frequency range 2 (FR2), or one of 6G frequency ranges, but the invention should not be limited thereto. In the embodiments of the invention, for the IQ data of a RAT (or an FR of a RAT), the UE 100 can adopt different interface (e.g., the AIQ interface(s), the DIQ interface(s), or the AIQ interface(s) and the DIQ interface(s)) based on the detection result associated with the IQ data of the RAT (or the FR of a RAT) to transmit the IQ data between the BB signal processing device of the UE 110 and the RF signal processing device of the UE 110. It should be noted that the UE 110 may operate concurrently with more than one RAT (or one FR of a RAT). In such cases this invention may be applied to each of the RATs (or each of the FRs) independently. For example, the UE 110 may be configured by the network node 120 to concurrently receive IQ data from both 5G FR1 and 5G FR2, and the interface between the BB signal processing device and the RF signal processing device used for receiving the IQ data from 5G FR1 may be dynamically switched to only AIQ interface(s), only DIQ interface(s), or both AIQ interface(s) and DIQ interface(s) according to criteria concerning the number of CCs, antennas, and total BW of 5G FR1, while the interface between the BB signal processing device and the RF signal processing device used for receiving the IQ data from 5G FR2 may also be dynamically, but independently to the interface switching of 5G FR1, switched to only AIQ interface(s), only DIQ interface(s), or both AIQ interface(s) and DIQ interface(s) according to criteria concerning the number of CCs, antennas, and total BW of 5G FR2. For the above example, whether or not specific interface resources (AIQ interface(s) and/or DIQ interface(s)) can be shared by 5G FR1 and 5G FR2 may be considered.

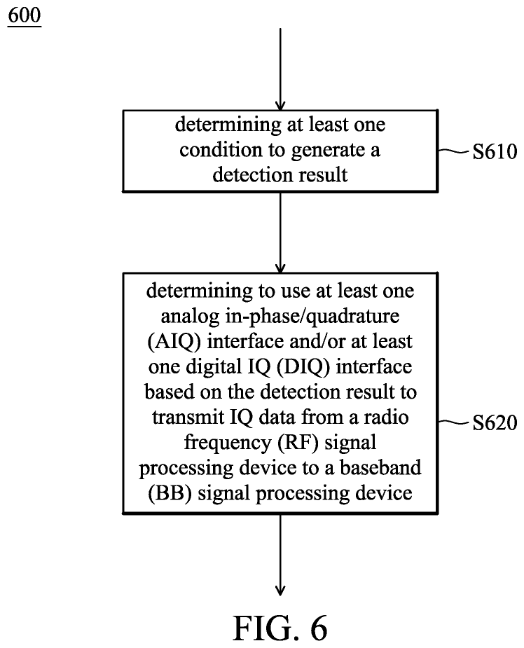

FIG. 6 is a flow chart illustrating an IQ interface switching method according to an embodiment of the invention. The IQ interface switching method can be applied to the wireless communications system 100. As shown in FIG. 6, in step S610, when the UE 110 receives the IQ data of a RAT (or an FR of a RAT) from the network node 120, the UE 110 may determine at least one condition associated with the IQ data of the RAT (or the FR of a RAT) to generate a detection result.

In step S620, the UE 110 may determine to use at least one analog in-phase/quadrature-phase (AIQ) interface and/or at least one digital IQ (DIQ) interface based on the detection result to transmit IQ data of the RAT (or the FR of a RAT) from a radio frequency (RF) signal processing device of a transceiver of the UE 110 to a baseband (BB) signal processing device of the transceiver of the UE 110.

According to an embodiment of the invention, in the IQ interface switching method, the IQ data may be associated with a radio access technology (RAT) or an FR of a RAT. That is, the IQ data is transmitted on a RAT or an FR of a RAT.

According to an embodiment of the invention, in the IQ interface switching method, the RAT or the FR of a RAT comprises a 4G, a 5G frequency range 1 (FR1), a 5G frequency range 2 (FR2), or one of 6G frequency ranges.

According to an embodiment of the invention, in the IQ interface switching method, the condition may comprise the number of antennas for the IQ data of the RAT (or the FR of a RAT), the number of component carriers (CCs) for the IQ data of the RAT (or the FR of a RAT), and/or the bandwidth (BW) of the RAT (or the FR of a RAT).

According to an embodiment of the invention, in the IQ interface switching method, the transceiver may determine to only use the AIQ interface to transmit the IQ data of the RAT (or the FR of a RAT) in response to the number of antennas and the number of CCs for the IQ data of the RAT (or the FR of a RAT) being not greater than a threshold. In addition, the transceiver may determine to use the DIQ interface or both of the AIQ interface and the DIQ interface to transmit the IQ data of the RAT (or the FR of a RAT) in response to the number of antennas and the number of CCs for the IQ data of the RAT (or the FR of a RAT) being greater than the threshold.

According to an embodiment of the invention, in the IQ interface switching method, each AIQ interface may comprise two or four wires and each AIQ interface may be used for one antenna and one CC.

According to an embodiment of the invention, in the IQ interface switching method, each DIQ interface may comprises a lane, an IQ data combining circuit and an IQ data dispatch circuit, and each DIQ interface may be used for one or more antennas and one or more CCs.

In the IQ interface switching method provided in the invention, the AIQ interface and the DIQ interface can be dynamically enabled for the IQ data transmission of a RAT or an FR of a RAT based on the detection result associated with the IQ data of the RAT (or the FR of a RAT). Therefore, in the IQ interface switching method provided in the invention, the operations for the AIQ interface and the DIQ interface will be more efficient and flexible.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An in-phase/quadrature-phase (IQ) interface switching method, comprising:
determining, by a transceiver of an apparatus, at least one condition to generate a detection result; and
dynamically determining, by the transceiver, to use at least one analog IQ (AIQ) interface and/or at least one digital IQ (DIQ) interface based on the detection result to transmit IQ data between a radio frequency (RF) signal processing device of the transceiver and a baseband (BB) signal processing device of the transceiver.

2. The IQ interface switching method of claim 1, wherein the IQ data is associated with a radio access technology (RAT) or a frequency range (FR) of a RAT.

3. The IQ interface switching method of claim 2, wherein the RAT or the frequency range of a RAT comprises a 4G, a 5G frequency range 1 (FR1), a 5G frequency range 2 (FR2), or one of 6G frequency ranges.

4. The IQ interface switching method of claim 1, wherein the at least one condition comprises the number of antennas for the IQ data, the number of component carriers (CCs) for the IQ data, and/or a bandwidth (BW).

5. The IQ interface switching method of claim 4, wherein the transceiver determines to use only the AIQ interface to transmit the IQ data in response to the number of antennas and the number of CCs for the IQ data being not greater than a threshold; and the transceiver determines to use the DIQ interface or both of the AIQ interface and the DIQ interface to transmit the IQ data in response to the number of antennas and the number of CCs for the IQ data being greater than the threshold.

6. The IQ interface switching method of claim 1, wherein each AIQ interface comprises two or four wires and each AIQ interface is used for one antenna and one CC.

7. The IQ interface switching method of claim 1, wherein each DIQ interface comprises a lane, an IQ data combining circuit and an IQ data dispatch circuit, and each DIQ interface is used for one or more antennas and one or more CCs.

8. An apparatus for in-phase/quadrature-phase (IQ) interface switching, comprising:
a transceiver, comprising a baseband (BB) signal processing device, a radio frequency (RF) signal processing device, at least one analog IQ (AIQ) interface, at least one digital IQ (DIQ) interface, and switch circuits inside the RF signal processing device and BB signal processing device; and
a decision unit, coupled to or inside the transceiver, configured to:
determine at least one condition to generate a detection result; and
dynamically determine, via the switch circuits of the transceiver, to use the at least one AIQ interface and/or the at least one DIQ interface based on the detection result to transmit IQ data between the RF signal processing device of the transceiver and the BB signal processing device of the transceiver.

9. The apparatus of claim 8, wherein the IQ data is associated with a radio access technology (RAT) or a frequency range (FR) of a RAT.

10. The apparatus of claim 9, wherein the RAT or the frequency range of the RAT comprises a 4G, a 5G frequency range 1 (FR1), a 5G frequency range 2 (FR2), or one of 6G frequency ranges.

11. The apparatus of claim 8, wherein the at least one condition comprises the number of antennas for the IQ data, the number of component carriers (CCs) for the IQ data, and/or a bandwidth (BW).

12. The apparatus of claim 11, wherein the transceiver determines to use only the AIQ interface to transmit the IQ data in response to the number of antennas and the number of CCs for the IQ data being not greater than a threshold; and the transceiver determines to use the DIQ interface or both of the AIQ interface and the DIQ interface to transmit the IQ data in response to the number of antennas and the number of CCs for the IQ data being greater than the threshold.

13. The apparatus of claim 8, wherein each AIQ interface comprises two or four wires and each AIQ interface is used for one antenna and one CC.

14. The apparatus of claim 8, wherein each DIQ interface comprises a lane, an IQ data combining circuit and an IQ data dispatch circuit, and each DIQ interface is used for one or more antennas and one or more CCs.

15. A transceiver for in-phase/quadrature-phase (IQ) interface switching, comprising:
a baseband (BB) signal processing device;
a radio frequency (RF) signal processing device;
at least one analog IQ (AIQ) interface, coupled to the BB signal processing device and the RF signal processing device;
at least one digital IQ (DIQ) interface, coupled to the BB signal processing device and the RF signal processing device;
a first switch circuit, coupled to one end of each AIQ interface involved in the IQ switching and one end of each DIQ interface involved in the IQ switching;
a second switch circuit, coupled to the other end of each AIQ interface involved in the IQ switching and the other end of each DIQ interface involved in the IQ switching; and
a decision unit, coupled to the first switch circuit and the second switch circuit, generating a detection result to control the first switch circuit and the second switch circuit,
wherein the first switch circuit and the second switch circuit are controlled so that the IQ data are transmitted between the RF signal processing device and the BB signal processing device by the at least one AIQ interface and/or the at least one DIQ interface based on the detection result associated with at least one condition.

16. The transceiver of claim 15, wherein the IQ data is associated with a radio access technology (RAT) or a frequency range (FR) of a RAT.

17. The transceiver of claim 16, wherein the RAT or the frequency range of the RAT comprises a 4G, a 5G frequency range 1 (FR1), a 5G frequency range 2 (FR2), or one of 6G frequency ranges.

18. The transceiver of claim 15, wherein the at least one condition comprises the number of antennas for the IQ data, the number of component carriers (CCs) for the IQ data, and/or a bandwidth (BW).

19. The transceiver of claim 18, wherein the transceiver determines to use only the AIQ interface to transmit the IQ data in response to the number of antennas and the number of CCs for the IQ data being not greater than a threshold; and the transceiver determines to use the DIQ interface or both of the AIQ interface and the DIQ interface to transmit the IQ data in response to the number of antennas and the number of CCs for the IQ data being greater than the threshold.

20. The transceiver of claim 15, wherein each AIQ interface comprises two or four wires and each AIQ interface is used for one antenna and one CC, and wherein each DIQ interface comprises a lane, an IQ data combining circuit and an IQ data dispatch circuit, and each DIQ interface is used for one or more antennas and one or more CCs.
